(19) United States
(12) Patent Application Publication
(10) Pub. No.: US 2006/0158893 A1
(43) Pub. Date: Jul. 20, 2006

(54) Automobile wheel illuminating device

(76) Inventor: John H. Wilkerson III, Birmingham, AL (US)

Correspondence Address: BUSH INTELLECTUAL PROPERTY LAW GROUP, LLC, P.O. BOX 381146, BIRMINGHAM, AL, 35238, US

(21) Appl. No.: 11/034,659

(22) Filed: Jan. 13, 2005

Related U.S. Application Data
(60) Provisional application No. 60/557,202, filed on Mar. 29, 2004.

(51) Int. Cl. B60Q 1/26

(52) U.S. Cl. 362/500

(57) ABSTRACT

A telescoping automobile wheel illuminating device having one end for attachment within a wheel well and an opposite end having a light source, wherein the device can be activated to extend the light source out of the wheel well to illuminate a tire rim and retract the light source back into the wheel well when not in use.

### REFERENCE TO RELATED APPLICATION

This nonprovisional patent application claims priority to U.S. Provisional Patent Application No. 60/557,202 filed Mar. 29, 2004, incorporated herein by reference.

### FIELD OF THE INVENTION

The present invention relates to lighting systems for illuminating external features of vehicles, and more particularly to an automated lighting system for illuminating vehicle wheels.

### BACKGROUND OF THE INVENTION

In order to distinguish and personalize the appearance of vehicles, owners frequently have aftermarket equipment and enhancements added to their vehicles. One such enhancement is replacing standard tire rims with customized rims, which can be quite expensive. Unfortunately, these customized rims cannot be appreciated at night unless a lighting system is installed on the vehicle that is designed to illuminate the tire rims. Present lighting systems, such as that disclosed in U.S. Pat. No. 5,558,426, have been developed to address this problem. However, these lighting systems are always visible, thus detracting from the appearance of the vehicle. Further, because these lighting systems are always exposed, they are more likely to be damaged by road debris, vandals, curbs, etc.

Accordingly, what is needed and is not found in the prior art is an automated lighting system for illuminating the tire rims of a vehicle that may be retracted out of sight during non-use of the vehicle or during day use or high speed use.

### SUMMARY OF THE INVENTION

The present invention is an automobile wheel illuminating device designed to illuminate a tire rim of a vehicle. The device comprises a pneumatic cylinder attached within the wheel well of a vehicle. Attached to the pneumatic cylinder is a light source. When the pneumatic cylinder is in a retracted position, the light source is within the wheel well. When the pneumatic cylinder is in an extended position, the light source is outside the wheel well such that the light source is directed towards the tire rim. A plurality of switches for operating the wheel illuminating device are located within the passenger compartment of the vehicle. These switches preferably include IN and OUT buttons for controlling the positioning of the light source and ON and OFF buttons for activating and deactivating the light source.

These and other features of the invention will become apparent from the following detailed description of the preferred embodiment of the invention.

### BRIEF DESCRIPTION OF THE DRAWINGS

FIG. 1 is an exploded perspective view of a preferred embodiment of the present invention.

FIG. 2 is a perspective view of a preferred embodiment of the present invention attached within the wheel well of a vehicle.

FIG. 3 is a perspective view of the embodiment of FIG. 2 with the light source extended and activated to illuminate a tire rim.

FIG. 4 is a perspective view of a passenger compartment of a vehicle showing the switches for controlling the invention.

### DETAILED DESCRIPTION OF THE PREFERRED EMBODIMENT

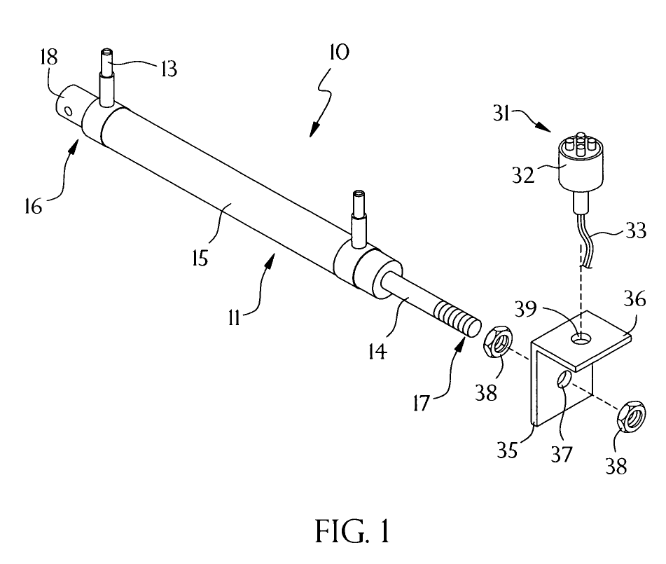

The present invention is an automobile wheel illuminating device 10 designed to illuminate the tire rim 22 of a vehicle 21. In a preferred embodiment shown in FIGS. 1-4, the device 10 comprises a pneumatic cylinder 11, such cylinders being well known in the art. An air compressor (not shown) is connected to the pneumatic cylinder 11 via one or more air tubes 13. The pneumatic cylinder 11 has an inner cylinder or piston 14 and an outer cylinder 15 for receiving the inner cylinder 14 therein. When activated, air is provided from the air compressor through the connecting tube 13 to the pneumatic cylinder 11, thereby extending the inner cylinder 14 out of the outer cylinder 15.

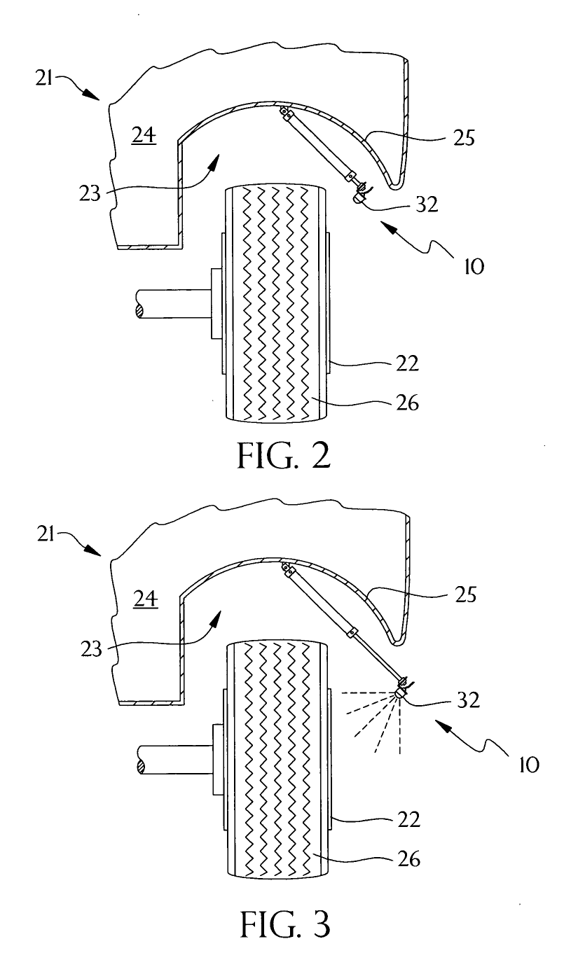

The pneumatic cylinder 11 has opposing first 16 and second 17 ends. Attached to the first end 16 of the pneumatic cylinder 11 is an attachment member 18 capable of being attached to the wheel well or housing of a vehicle 21. Various securing and coupling devices for attaching parts and products to vehicles are well known in the art and may be used as the attachment member. As best shown in FIGS. 2-3, an automobile wheel 26 is typically positioned within a wheel housing 23. The wheel housing 23 is typically positioned below the undercarriage 24. There is typically an arcuate boundary 25 between the undercarriage 24 and the wheel housing 23. In use, the attachment member 18 is attached to a vehicle 21 preferably at a point along the arcuate boundary 25. The location and orientation of the device 10 within the wheel housing 23 is such that the device 10 and the tire 26 do not interfere with one another.

Attached to the inner cylinder 14 at the second end 17 of the pneumatic tube 11 is an illumination member 31 preferably having one or more lights 32. The lights 32 are preferably light-emitting diodes (LED) connected via electrical wires 33 to the vehicle's electrical system (not shown). As best shown in FIG. 2, the position and angle of the device 10 are preferably such that when the inner cylinder 14 is retracted, the light source 32 is preferably within the wheel housing 23. As best shown in FIG. 3, when the inner cylinder 14 is extended, the light source 32 is preferably outside the wheel housing 23 so that the light source 32 may be directed towards the tire rim 22.

The light source 32 is preferably attached to an L-shaped bracket having first 35 and second 36 planar sections. The first section 35 preferably has a hole 37 located therein, through which is positioned one end of the inner cylinder 14. The inner cylinder 14 is preferably secured to the first section 35 by a pair of nuts 38, one on each side of the first section 35. The second section 36 preferably has a hole 39 located therein, through which is positioned the light source 32.

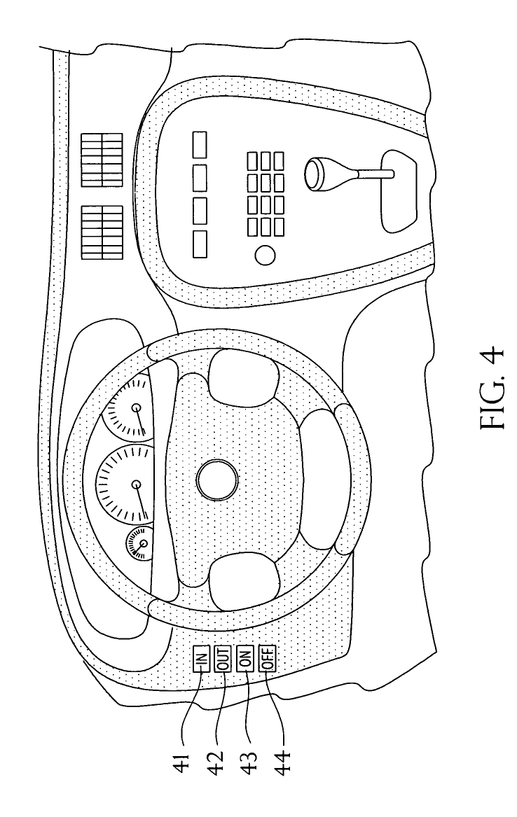

A plurality of activation switches for operating the wheel illuminating device 10 are preferably located within the passenger compartment of the vehicle 21, shown in FIG. 4, wherein these switches preferably include IN 41 and OUT 42 buttons for controlling the positioning of the light source 32 and ON 43 and OFF 44 buttons for activating and deactivating the light source 32. When the OUT button 42 is pressed, the air compressor is activated to extend the inner cylinder 14 from the outer cylinder 15. When the IN button 41 is pressed, the air flow is reversed to retract the inner cylinder 14 back into the outer cylinder 15. The positions of the buttons 41,42,43,44 are preferably such that they may all be reached by an individual sitting in the driver's seat of the vehicle 21.

Preferably, the vehicle 21 has a device 10 for each tire 26. For this design, each button 41,42,43,44 would preferably simultaneously perform its corresponding function for all four devices 10. Thus, for example, the user would be able to simultaneously illuminate the light sources 32 on all four devices 10 by pressing the ON button 43. The design of the apparatus 10 allows it to be retrofitted into existing automobiles as well as built into new ones. Elements for operating the invention such as the battery and the air compressor are preferably positioned under the hood or in the trunk of the vehicle 21 but may be positioned in other locations.

While the invention has been shown and described in some detail with reference to a specific exemplary embodiment, there is no intention that the invention be limited to such detail. On the contrary, the invention is intended to include any alternative or equivalent embodiments that fall within the spirit and scope of the invention as described above and as recited in the appended claims.

1. An apparatus for illuminating the tire rim of a vehicle, comprising:
a. a telescoping member;
b. an attachment member on a first end of said telescoping member for securing said telescoping member to the vehicle within a wheel well; and
c. a light on a second end of said telescoping member in electrical communication with a power source;
d. wherein said telescoping member is operable to extend said light outside of the wheel well to illuminate the tire rim and retract said light back into the wheel well.

2. An apparatus according to claim 1, wherein said telescoping member comprises a pneumatic cylinder in fluid communication with an air compressor.

3. An apparatus according to claim 1, wherein said light comprises at least one light-emitting diode.

4. An apparatus for illuminating the tire rim of a vehicle, comprising:
a. a telescoping member;
b. securing means on a first end of said telescoping member for securing said telescoping member to the vehicle within a wheel well; and
c. a light on a second end of said telescoping member in electrical communication with a power source;
d. wherein said telescoping member is operable to extend said light outside of the wheel well to illuminate the tire rim.

5. An apparatus according to claim 4, wherein said telescoping member comprises a pneumatic cylinder in fluid communication with an air compressor.

6. An apparatus according to claim 4, wherein said light comprises at least one light-emitting diode.

7. A lighting system for illuminating the tire rims of a vehicle, comprising:
a. at least one telescoping member secured within each wheel well of the vehicle;
b. an attachment member on a first end of each said telescoping member for securing said telescoping member to the wheel well;
c. a light on a second end of each said telescoping member, wherein said light is in electrical communication with a remote power source; and
d. a control panel within the passenger cabin of the vehicle, wherein said control panel is operable to activate each said telescoping member to extend said light on its said second end outside of the wheel well and to activate each said light to illuminate a tire rim, wherein said control panel is further operable to activate each said telescoping member to retract said light on its said second end inside of the wheel well and to deactivate each said light.

8. An apparatus according to claim 7, wherein each said telescoping member comprises a pneumatic cylinder in fluid communication with a remote air compressor.

9. An apparatus according to claim 7, wherein each said light comprises at least one light-emitting diode.
